(19) United States
(12) Patent Application Publication
(10) Pub. No.: US 2021/0346831 A1
(43) Pub. Date: Nov. 11, 2021

(54) ANTIVIRAL GRAPHENE OXIDE AIR FILTRATION DEVICE AND ASSOCIATED METHODS

(71) Applicant: G6 Materials Corp., Ronkonkoma, NY (US)

(72) Inventors: Daniel Stolyarov, Middle Island, NY (US); Elena Polyakova, Bohemia, NY (US); Valentyna Voskresenska, Miller Place, NY (US)

(73) Assignee: G6 Materials Corp., Ronkonkoma, NY (US)

(21) Appl. No.: 17/313,727

(22) Filed: May 6, 2021

Related U.S. Application Data
(60) Provisional application No. 63/021,996, filed on May 8, 2020.

(51) Int. Cl. B01D 46/00; B01D 39/20; B01D 39/16; B01D 46/10; A62B 23/02

(52) U.S. Cl. CPC B01D 46/0028; B01D 39/2065; B01D 46/0001; B01D 39/1615; B01D 2279/65; A62B 23/025; B01D 2239/0442; B01D 2239/0492; B01D 2239/10; B01D 46/10

(57) ABSTRACT

An air filtration device may include a high efficiency particulate air (HEPA) filtration media configured to filter particulates of at least 0.3 microns in diameter. The HEPA filtration media may include graphene oxide (GO) as an antibacterial and antiviral material configured to inactivate trapped micro-organisms. The HEPA filtration media may be a mat of randomly arranged fibers coated with GO or a mat of randomly arranged GO fibers. The device may be shaped and configured for use in an air purification system or for use in a protective face mask.

### RELATED APPLICATIONS

This application claims priority under 35 U.S.C. § 119(e) of U.S. Provisional Patent Application Ser. No. 63/021,996 (Attorney Docket No. 4460 00017) filed on May 8, 2020 and titled ANTIVIRAL GRAPHENE OXIDE AIR FILTRATION DEVICE AND ASSOCIATED METHODS, The content of this application is incorporated herein by reference.

### FIELD OF THE INVENTION

The present invention relates to applications, systems and methods for air filtration, and more particularly to air filtration including the use of graphene oxide and associated antiviral properties.

### BACKGROUND

People spend their everyday activities in high populated environments, which increase their contact with many pathogens. The high risk of cross-infection in these places are causing serious health issues and elevates the risk of the pandemics. Aerosol transmission, also known as air borne transmission, of bacteria and viruses is responsible for serious respiratory infection. The main exchange of airborne bacteria and viruses happens when people cough, sneeze, talk, or exhale. While the actual virus may be roughly 0.1-0.2 microns in diameter, an infected person generates respiratory droplets of different sizes (from 0.5 to 16 microns). When the airborne bacteria or viruses attach to dust or other particles, it increases their air stability and thus, they can transmit for a longer distance. Depending on their size and environment humidity, droplets can remain airborne from minutes to hours. If inhaled droplets contain viruses and bacteria, the risk of the infection is greatly increased.

As such, it is especially important to keep the air in the everyday environment clean and safe. Today, the mechanical air filtration technology is one of the most efficient and safe. Mechanical filters remove even small droplets and particles from the air by trapping them on filter materials, HEPA (high efficiency particulate air) filters are capable to capture up to 99.97% of particles with 0.3-micron size. These filters are intensively used in healthcare and medical environments to prevent viruses and infection spreading.

Most modern HEPA filters are formed of interlaced glass fibers that are twisted and turned in myriad directions to create a fibrous maze. As particles traverse this web, they're taken out of circulation in the following ways: Direct Impaction—Large contaminants, such as certain types of dust, mold, and pollen, travel in a straight path, collide with a fiber, and stick to it; Sieving—The air stream carries a particle between two fibers, but the particle is larger than the gap, so it becomes ensnared; Interception—Airflow is nimble enough to reroute around fibers, but, thanks to inertia, particles continue on their path and stick to the sides of fibers; and Diffusion—Small, ultrafine particles move more erratically than larger ones, so they're more likely to hit and stick to fibers.

HEPA filters are efficient in mitigating viral infection even though the size of the virus is smaller than the size of the filter pores. In a four-year study, it was proven that HEPA filters are efficient in mitigation of the infections caused by Mycoplasma hyopneumoniae. All filter types equally reduced the risk of airborne transmission of both pathogens, compared to non-filtered controls, supporting further application in the field. All filter types equally reduced the risk of airborne transmission of both pathogens, compared to non-filtered controls. HEPA filters are also efficient at mitigating SARS (severe acute respiratory syndrome) airborne viruses. Another study showed that portable HEPA air filtration units are capable of removing 87% of viruses from the air. However, it should be understood the HEPA filters just trap the particles, they are not destroying them. The viruses are getting absorbed on the surface of the filter. If the virus is sufficiently robust, there is a chance that it can detach from the surface of the filter and reinsert itself into the airflow.

One potential approach is to replace the filters frequently. However, this approach is not practical as the high grade HEPA filters are relatively expensive. Ultraviolet light may be tool for fighting germs. The germicidal efficiency of UV light depends on the wavelength. FIG. 1 is a graph that illustrates the efficiency of UV light to kill E. coli bacteria.

As seen in FIG. 1, the UV radiation is the most efficient in the range 260-265 nm referred to as UVC because it corresponds to the DNA absorption peak. FIG. 1 also shows the spectrum of low-pressure mercury lamp. The spectral line at 254 nm has a good overlap with the germicidal effectiveness curve. That is why, in air purifiers used in medical and biomedical environments HEPA filters are coupled with UV-light sources. UV-light kills viruses and bacteria, and play a disinfection role for HEPA filters. However, many wonder how adequate the UV approach is in view of the time needed for exposure. The rate of virus deactivation by UV light is described by the exponential law; S(t)=e−kIt . . . Eq. 1, where k is standard deactivation rate specific for the specie. The deactivation rates for various viruses are listed in the reference Tang, W. Z., & Sillanpaa, M. (2015). Environmental Technology, 36(11), 1464-1475., where t—time of the exposure and I—is the intensity of the UV source.

As it follows from the equation 1, for UV light to provide an adequate disinfection effect, the intensity of the UV light should be strong enough so that the exposure time required for efficient virus inactivation is less than the average time that virus spends on the surface of the filter. HEPA filters are fabricated either from polymer filaments or fiberglass. Such surfaces are inert, and viruses could survive on them for days. The source of the UV light that could provide a sufficient disinfectant rate is expensive. Also, the high intensity UV light is damaging for the HEPA filter material.

An alternative and cheaper approach may be to implement an effective disinfection layer to the filter surface directly. Such a layer will inactivate the microorganisms which are trapped by the filter media.

This background section is intended to introduce the reader to various aspects of typical technology that may be related to various aspects or embodiments of the present invention, which are described and/or claimed below. This discussion is believed to be useful in providing the reader with background information to facilitate a better understanding of the various aspects and embodiments of the present invention. Accordingly, it should be understood that these statements are to be read in light of, and not as admissions of, the prior art.

### SUMMARY OF THE INVENTION

It is an object of the present embodiments to provide a system, device and method for effective disinfection of a filter surface to inactivate the microorganisms trapped by the filter media.

This and other objects, advantages and features in accordance with the present embodiments may be provided by an air filtration device including a high efficiency particulate air (HEPA) filtration media configured to filter particulates of at least 0.3 microns in diameter, wherein the HEPA filtration media comprises graphene oxide (GO) as an antibacterial and antiviral material configured to inactivate trapped micro-organisms.

In certain embodiments, the HEPA filtration media may be a mat of randomly arranged fibers coated with GO. The GO may be deposited on the fibers, e.g. ultrasonically deposited on the fibers. The GO may be graphene oxide aerogel.

In certain embodiments, the HEPA filtration media may be a mat of randomly arranged GO fibers. In other embodiments, the HEPA filtration media may be shaped and configured for use in an air purification system. Alternatively, or in addition to, the HEPA filtration media may be shaped and configured for use in a protective face mask.

In certain embodiments, the GO may be functionalized GO insoluble in water. Alternatively, or in addition to, the GO may be a GO-chitosan material.

Another embodiment of the present invention is directed to a method of making an air filtration device, the method comprising: providing a high efficiency particulate air (HEPA) filtration media configured to filter particulates of at least 0.3 microns in diameter; wherein the HEPA filtration media comprises graphene oxide (GO) as an antibacterial and antiviral material configured to inactivate trapped micro-organisms.

In certain embodiments, providing the HEPA filtration media may include coating a mat of randomly arranged fibers with GO. The coating may include depositing the GO on the fibers, e.g., ultrasonically depositing the GO on the fibers. In certain embodiments, the GO may be graphene oxide aerogel.

In certain embodiments, providing the HEPA filtration media may include forming a mat of randomly arranged GO fibers. In other embodiments, the HEPA filtration media may be shaped and configured for use in an air purification system. Alternatively, or in addition to, the HEPA filtration media may be shaped and configured for use in a protective face mask. The GO may be functionalized GO insoluble in water. The GO may be a GO-chitosan material.

### BRIEF DESCRIPTION OF THE DRAWINGS

FIG. 1 is a graph that illustrates the efficiency of UV light wavelengths to kill E. coli bacteria.

FIG. 2 is a schematic diagram illustrating the antiviral properties of GO.

FIG. 3 is a perspective view illustrating an embodiment of an air purification system including a HEPA filter with graphene oxide surface (GO-HEPA) in accordance with features of the present invention.

FIG. 4 is a perspective view illustrating a portion of an example embodiment of an ultrasonic deposition method of fabrication of a GO-HEPA filter of FIG. 3 in accordance with features of the present invention.

FIG. 5 is a Scanning Electron Microscope (SEM) image of araphene oxide aerogel, for example, as used in a fabrication method of the present invention.

FIG. 6 is an SEM image of graphene oxide fiber, for example, as used in another fabrication method of the present invention.

FIG. 7 is a perspective view of a face mask including a GO-HEPA filtration device in accordance with features of the present invention.

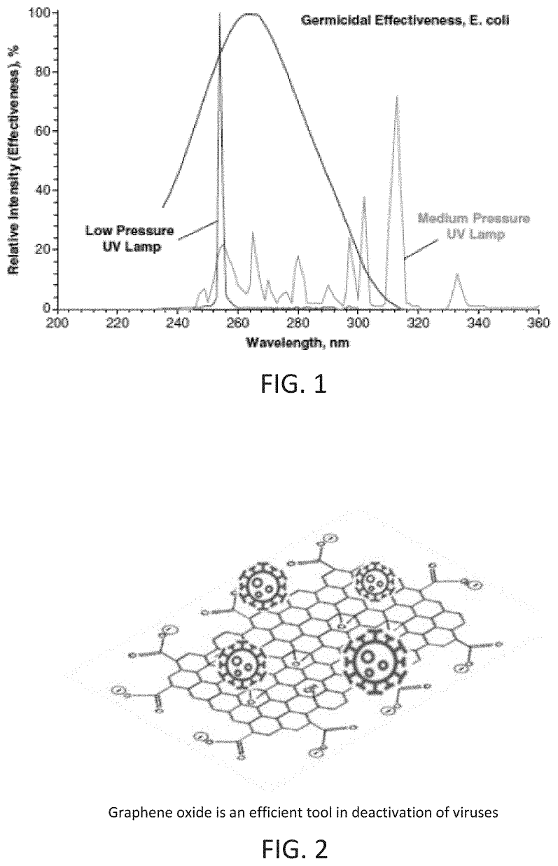

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art will appreciate that the following descriptions of the embodiments of the present invention are illustrative and are not intended to be limiting in any way, Other embodiments of the present invention will readily suggest themselves to such skilled artisans having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

It may be needed to add an effective and inexpensive layer to the filters to inactivate the microorganisms which are trapped by the filter media. Graphene, the thinnest material in the known universe, is a material with transformative potential and application in multiple industries. Graphene is readily visualized as a hexagonal lattice of carbon atoms in a honeycomb-like structure. Grapheme's crystalline structure affords its unique optical, thermal, mechanical, antibacterial, electrical, and thermal properties. Graphene Oxide (GO) is the oxidized derivative of graphene possessing oxygen functionalities on its edges such as carboxylic (—COOH), carbonyl (—C═O), and hydroxyl (—OH) groups on both accessible sides. The antibacterial effects of GO can be explained by various mechanisms such as membrane stress, oxidative stress, entrapment, basal plane, and photo-thermal effect. Furthermore, sharp edges of the nanosheets of GO may physically damage the bacterial. In addition to that, reactive oxygen species (ROS) can be generated on GO surface, which results in bacterial inhibition.

Many studies have demonstrated that the effectiveness of graphene oxide as an antibacterial and antiviral candidate relates to its high surface area, great thermal stability, physicochemical properties and biocompatibility. Most of the studies relate to the antimicrobial properties of GO. However, several recent studies demonstrated that graphene oxide and its derivatives exhibit promising antiviral properties. FIG. 2 is a schematic diagram illustrating the antiviral properties of GO. Ronit Sarid et al. studied the antiviral activity of graphene oxide GO and partially reduced sulfonated GO toward herpes simplex virus type-1 (HSV-1) infections. They showed that their systems blocked HSV-1 infection and suggested that the viral attachment blocking was the main inhibition mechanism and negative charge density was a dominant factor.

The antiviral activity of graphene oxide against pseudorabies virus (PRV, a DNA virus) and porcine epidemic diarrhea virus (PEDV, an RNA coronavirus) were evaluated by research group of Heyou Han. They examined GO, rGO, GO-PDDA and GO-PVP (GO conjugated with cationic poly(diallyldimethylammonium chloride) and nonionic polyvinylpyrrolidone). These studies demonstrated that the electrostatic interaction offers the negatively charged sharp-edged GO more chances to directly interact with the positively charged virus particles and, as a result, destroy and inactivate the virus structures. Authors proposed the antiviral mechanism of GO may be attributed to the negative charge and single-layer nanosheet structure of GO.

Yi-Ning Chen et al. investigated the antiviral activity of graphene oxide GO sheets and GO sheets with silver particles (GO-Ag) against enveloped and non-enveloped viruses, feline coronavirus (FCoV) with an envelope and infectious bursal disease virus (IBDV) without an envelope. GO sheets with silver particles exhibited antiviral activity against both enveloped viruses and non-enveloped viruses, whereas GO sheets alone inhibits the infection only of enveloped viruses. Based on early studies of the interactions between GO and lipid membranes, Chen proposed the mechanism attributed to four main reasons of antiviral activity of GO toward to envelope coronavirus: negatively charged GO can absorb to positively charged lipid membranes and induce the rupture of lipid membranes; strong association between lipid tans exposed from the ruptured lipid membrane with the aromatic plane of the GO sheet; the interactions between GO and lipid membrane can attract the absorption of more lipid membranes; and rupture of liquid membrane by GO.

Notably, all studies showed that GO exhibits significant antiviral properties even at a low non-cytotoxic concentration (1.5 μg/mL).

Also, graphene oxide can be non-covalently functionalized by biomolecules and polymers by π-π interactions, van der Waals forces, ionic interactions, and hydrogen bonding and there are several hydrophilic macromolecules utilized for covalent functionalization of GO.

Graphene oxide has a low toxicity, is easy to process, and can be produced in large scale and possess high efficiency at exceptionally low dosages which makes it a great candidate to use in this technology.

Furthermore, there is a potential to increase the antimicrobial/antiviral efficiency of graphene oxide. For instance, it may be functionalized by organic molecules, biomolecules, or nanocomposites with inorganic nanoparticles, such as silver, zinc oxide etc., as well as the composites of graphene oxide with biopolymers, such as chitosan which is readily available product with well-known antimicrobial/antifungal activity. Chitosan is a linear polysaccharide composed of randomly distributed β-(1→4)-linked D-glucosamine (deacetylated unit) and N-acetyl-D-glucosamine (acetylated unit). It is made by treating the chitin shells of shrimp and other crustaceans with an alkaline substance, such as sodium hydroxide.

Chitosan is a biopolymer, a deacetylated form of chitin. Several scientific studies (e.g., Polimeros vol. 19 no. 3 São Carlos 2009) show the broad antimicrobial spectrum to which gram-negative, gram-positive bacteria and fungi are highly susceptible. There are a variety of theories explaining the antibacterial properties of chitosan. Three antibacterial mechanisms have been proposed: i) the ionic surface interaction resulting in wall cell leakage; ii) the inhibition of the mRNA and protein synthesis via the penetration of chitosan into the nuclei of the microorganisms; and iii) the formation of an external barrier, chelating metals and provoking the suppression of essential nutrients to microbial growth.

Chitosan can be made in forms of fibers by various methods including electrospinning (e.g., as discussed in Electrospinning of Chitosan, by K. Okhawa et al. Macromol. Rapid Commun. 2004,25, 1600-1605) or by extrusion (e.g., as discussed in Albanna, M. Z., Bou-Akl, T. H., Blowytsky, O., Walters, H. L., & Matthew, H. W. T. (2013). Chitosan fibers with improved biological and mechanical properties for tissue engineering applications. Journal of the Mechanical Behavior of Biomedical Materials, 20, 217-226. Also, chitosan could be formed as pellets by dropping the chitosan solution into a coagulation bath.

Chitosan also forms composite materials with graphene oxide. This material has improved mechanical properties. It may be expected that antimicrobial properties will be amplified in a synergetic way.

The present invention allows to improve the efficiency of air purifiers equipped with HEPA filters, and other types of filters, by using the antimicrobial and antiviral properties of graphene oxide/or its derivatives without significant increasing of the cost of the air purifying device. The advantage of using graphene oxide in HEPA filters can be explained by its high effectiveness against bacteria due to its dual physical and chemical mechanisms.

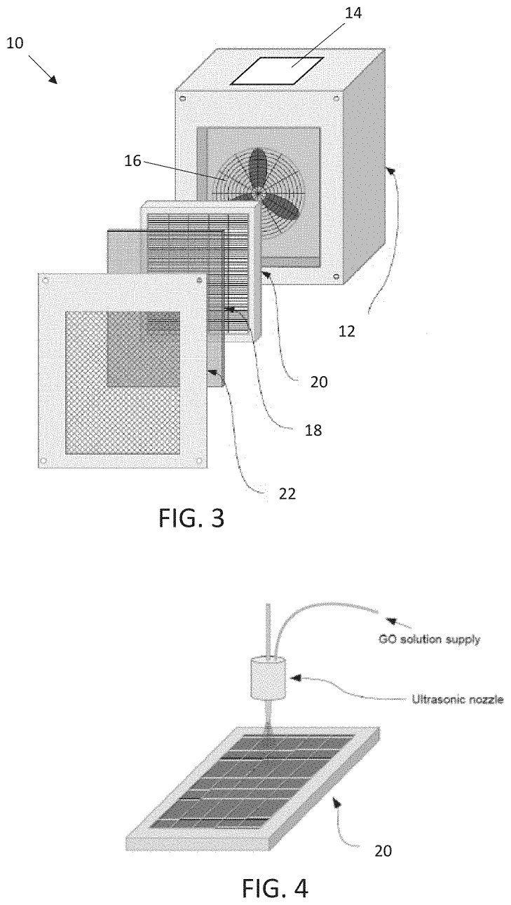

An embodiment of the proposed air purification system 10 is shown in FIG. 3. The system 10 includes a main block 12 or housing that includes the control electronics 14 as well as a fan 16 that is configured to provide a sufficient air flow through the set of filters. The filter set includes a preliminary filter 18 that captures large particles, and a GO HEPA air filtration device 20 which is a HEPA filter with graphene oxide surface. The filter set can also include other filters such as carbon filter (not shown) that captures volatile organic compounds (VOCs), and may also be equipped with UV lamps (not shown) for better germicidal efficiency. A front panel 22 may be included to secure the filter set to the main block 12.

As discussed above, the viruses trapped by the GO-HEPA filtration device 20 may be deactivated via several possible ways, for example: Contaminated with a microorganism's droplet nuclei run into a filter fiber and get trapped by interaction of negatively charged sharp-edged GO with the positively charged virus particles (e.g. FIG. 2); The membranes of microorganisms (viruses, bacteria etc.) are blocked and damaged by sharp edges of GO; and/or Damaged and undamaged microorganisms are destroyed by the chemical oxidation process induced by GO over time.

In another embodiment of the invention the antiviral GO-HEPA air filtration device 20 (e.g. HEPA filter with GO coating) is used in fabrication of a protective face mask 70 (FIG. 7), which is also a personal air purification device. The main difference between the regime of operation of the face mask 70 as compared to the above-described room air purification device 10 is that the mask is exposed to high and rapidly changing level of humidity, which could be damaging for the graphene oxide coating considering the affinity of the graphene oxide to moisture. An approach to overcome this technical difficulty is to use functionalized graphene oxide insoluble in water, which could be done by proper functionalization and/or grafting graphene oxide, for example, as discussed in “Harnessing the chemistry of graphene oxide” by Dreyer. D. R., Todd, A. D., & Bielawski, C. W. (2014). Chemical Society Reviews, 43(15), 5288.

### Fabrication of GO-HEPA Filters

There may be several approaches for fabrication of the HEPA filters with GO surface, and some embodiments are described below. A first embodiment may be to deposit a GO solution to the surface of a HEPA filter. GO easily dissolves in water and due to the monoatomic nature of the GO platelets, it sticks to the exposed surface.

The GO solution could be deposited on the surface of the HEPA filter by submerging the filter into the GO solution. The amount of the GO being deposited to the filter could be easily controlled by the solution concentration. A potential drawback of this method is that the water could damage the filter reducing its effective surface area, and diminishing its filtration capability.

Another embodiment is directed to ultrasonic deposition which is an elegant method of fabrication of the GO-HEPA filters 20. FIG. 4 is a perspective view illustrating a portion of an example embodiment of an ultrasonic deposition method of fabrication of a GO-HEPA filter 20 in accordance with features of the present invention. In this method, the deposition of GO solution is performed by an ultrasonic nozzle. The ultrasonic nozzle has a tip vibrating at the ultrasonic frequency and breaking the liquid solution into small droplets, thereby providing uniform deposition. The ultrasound treatment is also beneficial for the GO solution to prevent agglomeration of the GO platelets.

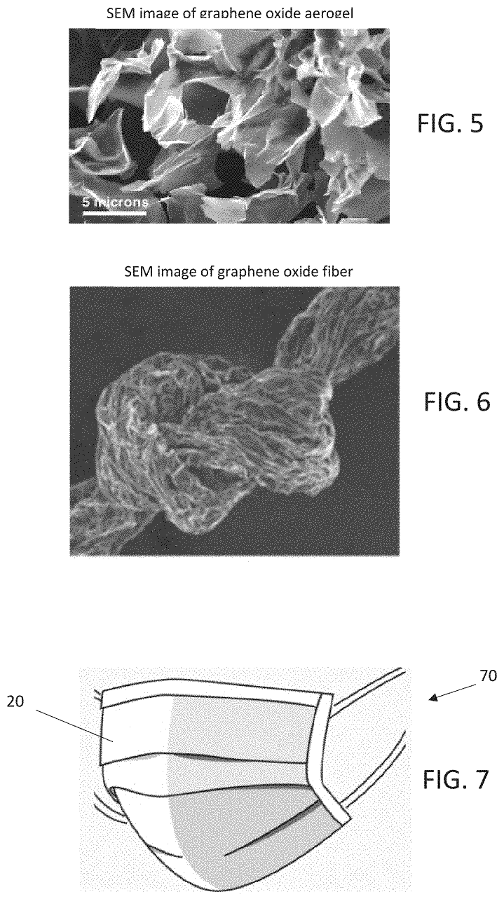

Another potential embodiment to fabricate the air filter with GO surface is to produce granules of graphene oxide aerogel, that is packaged in a similar manner as the carbon filters that are used for mitigation of VOC, i.e. sandwiched in between two layers of light fabric. The graphene oxide aerogels can be prepared by freeze drying a GO solution. FIG. 5 is a Scanning Electron Microscope (SEM) image of graphene oxide aerogel, for example, as used in the method of the present invention.

Alternatively, there is also an embodiment to manufacture the true HEPA filters using GO fibers. The GO can be converted to fibers by wet-spinning. In this method the concentrated GO solution is passed through a spinneret submerged into a coagulation bath. The resulting fibers have large specific surface area and could be efficiently used in fabrication of the GO-HEPA filters. FIG. 6 is an SEM image of graphene oxide fiber, for example, as used in the method of the present invention.

Another embodiment with possibly more economical potential is to make filters from GO-chitosan fibers or GO-chitosan beads. Chitosan powder is readily available product with well-known antimicrobial/antifungal activity. Thus, the use of the chitosan in the filter production will increase its efficiency. GO-chitosan fibers can be prepared using a wet spinning method. GO-chitosan beads can be prepared using coagulation bath.

A preferred method may be to cover highly porous media with graphene oxide and then packaged in a similar manner as the carbon filters. Microporous carbonaceous adsorbents such as activated carbon, carbon nanotube, carbon fiber as well as other silica materials such as microporous-mesoporous zeolite can be used as a such media. For instance, activated carbon pellets produced either from natural or synthetic materials have a large surface area. Such material upon the treatment with graphene oxide, can produce a highly efficient active surface to deactivate microorganisms.

### Other Potential Procedures are Noted Below

Graphene oxide can be synthesized from graphite using the modified Hammers method. The obtained paste or powder of graphene oxide is dissolved in a solvent and sonicated in an ultrasonic bath to obtain a fully homogeneous solution. Suitable solvents include, but are not limited to, water, alcohols, such as methanol, ethanol, isopropanol, or a combination in different proportions, The concentration of the graphene oxide in the solution can be 0.01 to 10 g/L, for example.

A professional spray gun with 1.3-1.4 mm nozzle may be used to apply the graphene oxide solution on the surface of the HEPA filter. Air pressure and the desired fluid flow volume can be adjusted. After spraying and drying GO coating formats in microns thickness.

Also, the filter can be fully immersed in graphene oxide solution then dried in the oven.

GO foam granules can be produced from highly concentrated water solution of GO (15-40 g/L) using the Dewar cylinder with liquid nitrogen. The size distribution of the granules can be varied through selection of the concentration of solution, and spray equipment parameters, The freezing granules should be dried with lyophilizer (e.g. vacuum below 10 mbar; −50 freeze drier) for 4 days.

GO fibers can be prepared by addition of ammonia drop by drop to the high concentration GO solution (pH˜10-11). After all the air bubbles should be removed by centrifugation and GO solution may be continuously extruded from a nozzle and coagulated in the mixture of methanol and ethyl acetone to form NGO fibers. After immediate air-drying, the fibers can be finally wound onto a reel.

Activated carbon pellets may be washed by deionized water and dried at 20-60° C. The resulting pellets are immersed in Graphene Oxide dispersion for 30 min., then filtered off and dried at 60-65° C. Suitable solvents for GO dispersion include, but are not limited to, water, alcohols, such as ethanol, isopropanol, or a combination in different proportions. The concentration of the graphene oxide in the solution can be 0.01-1% wt.

Graphene Oxide (in any form: e.g., powder, paste, dispersion) (at 2-30%) may be dispersed into distilled or deionized water and sonicated for 30-60 min. A chitosan solution may be prepared by dissolving chitosan powder in a 3-10% solution of suitable acid, preferably formic or acetic acid. The mixture can be stirred or sonicated vigorously to make chitosan disperse homogeneously. Finally, both solutions are mixed to obtain the homogeneous and stable GO/chitosan solution with a desirable concentration of GO (1-15%). After standing of the solution for at least 20 min under vacuum, the GO/chitosan solution may be injected through a 0.5 mm diameter spinneret into the coagulation bath containing 1-2 M aqueous solution of NaOH and collected on a rotating spool The coagulated fibers are washed by deionized water, then ethanol and dried to a constant weight at a relative humidity of 0-20% and at temperature 20° C.-60° C. The beads can be prepared by dropping of the GO-chitosan solution into the coagulation bath containing 1-2 M aqueous solution of NaOH, then filtered and washed by deionized/distilled water, by solution of 50% aqueous glutaraldehyde in methanol, and finally by ethanol. The foregoing disclosure provides illustration and description but is not intended to be exhaustive or to limit the implementations to the precise form disclosed. Modifications and variations are possible considering the above disclosure or may be acquired from practice of the implementations.

Even though particular combinations of features are disclosed in the specification, these combinations are not intended to limit the disclosure of possible implementations. In fact, many of these features may be combined in ways not specifically recited in the claims and/or disclosed in the specification.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As may be used herein, the terms “substantially” and “approximately” provides an industry-accepted tolerance for its corresponding term and/or relativity between items. Such an industry-accepted tolerance ranges from less than one percent to fifty percent. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module). As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional budding blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While particular combinations of various functions and features of the present invention have been expressly described herein, other combinations of these features and functions are likewise possible. The present invention is not limited by the particular examples disclosed herein and expressly incorporates these other combinations.

The embodiments of the invention described herein are exemplary and numerous modifications, variations and rearrangements can be readily envisioned to achieve substantially equivalent results, all of which are intended to be embraced within the spirit and scope of the invention. Further, the purpose of any included abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The above description provides specific details, such as material types and processing conditions to provide a thorough description of example embodiments. However, a person of ordinary skill in the art would understand that the embodiments may be practiced without using these specific details.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

That which is claimed is:

1. An air filtration device comprising:
a high efficiency particulate air (HEPA) filtration media configured to filter particulates of at least 0.3 microns in diameter;
wherein the HEPA filtration media comprises graphene oxide (GO) as an antibacterial and antiviral material configured to inactivate trapped micro-organisms.

2. The air filtration device according to claim 1, wherein the HEPA filtration media comprises a mat of randomly arranged fibers coated with GO.

3. The air filtration device according to claim 2, wherein the GO is deposited on the fibers.

4. The air filtration device according to claim 2, wherein the GO is ultrasonically deposited on the fibers.

5. The air filtration device according to claim 1, wherein the GO comprises graphene oxide aerogel.

6. The air filtration device according to claim 1, wherein the HEPA filtration media comprises a mat of randomly arranged GO fibers.

7. The air filtration device according to claim 1, wherein the HEPA filtration media is shaped and configured for use in an air purification system.

8. The air filtration device according to claim 1, wherein the HEPA filtration media is shaped and configured for use in a protective face mask.

9. The air filtration device according to claim 8, wherein the GO comprises functionalized GO insoluble in water.

10. The air filtration device according to claim 1, wherein the GO comprises GO-chitosan material.

11. A method of making an air filtration device, the method comprising:
providing a high efficiency particulate air (HEPA) filtration media configured to filter particulates of at least 0.3 microns in diameter;
wherein the HEPA filtration media comprises graphene oxide (GO) as an antibacterial and antiviral material configured to inactivate trapped micro-organisms.

12. The method according to claim 11, wherein providing the HERA filtration media comprises coating a mat of randomly arranged fibers with GO.

13. The method according to claim 12, wherein coating comprises depositing the GO on the fibers.

14. The method according to claim 12, wherein coating comprises ultrasonically depositing the GO on the fibers.

15. The method according to claim 11, wherein the GO comprises graphene oxide aerogel.

16. The method according to claim 11, wherein providing the HEPA filtration media comprises forming a mat of randomly arranged GO fibers.

17. The method according to claim 11 wherein the HEPA filtration media is shaped and configured for use in an air purification system.

18. The method according to claim 11, wherein the HEPA filtration media is shaped and configured for use in a protective face mask.

19. The method according to claim 18, wherein the GO comprises functionalized GO insoluble in water.

20. The method according to claim 11, wherein the GO comprises GO-chitosan material.
